(19) United States
(12) Patent Application Publication
(10) Pub. No.: US 2009/0107922 A1
(43) Pub. Date: Apr. 30, 2009

(54) MEMBRANE, WATER TREATMENT SYSTEM, AND ASSOCIATED METHOD

(75) Inventors: Bing Zhang, Shanghai (CN); Su Lu, Shanghai (CN); Jing Li, Shanghai (CN); Hua Li, Shanghai (CN); Ruzhou Zhang, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/925,163

(22) Filed: Oct. 26, 2007

(51) Int. Cl. B01D 27/08; B01D 35/26; B01D 37/02; B01D 39/14

(52) U.S. Cl. 210/749; 210/137; 210/484; 210/496

(57) ABSTRACT

A membrane assembly is provided that includes a support comprising a micro-porous material; and an insoluble layer secured to a surface of the support. The insoluble layer is a reaction product of a reactant solution comprising a chain-capping reagent. A system and associated method are provided also.

### BACKGROUND

1. Technical Field

The invention includes embodiments that relate to a membrane. The invention includes embodiments that relate to a water treatment system. The invention includes embodiments that relate to a method of making and/or using a membrane and a water treatment system.

2. Discussion of Art

Semi-permeable membranes play a part in processes for industrial and consumer applications. Industrial and consumer applications may include water purification and selective separation processes. The membranes operate in separation devices and allow selective components of a solution or a dispersion to pass through the membrane. Fluid that passes through the membrane is permeate. Components that do not pass through the membrane are the retentate.

An application for semi-permeable membranes is in reverse osmosis (RO). In a reverse osmosis process a solution is passed across a membrane by a pressure differential across the membrane, with the retentate side under relatively higher pressure than the permeate side. The pressure overcomes the osmotic pressure caused by the concentration gradient and forces solvent through the membrane as permeate. During this process, at least some solute does not pass through the membrane and the solute concentration in the retentate increases.

The performance of an RO membrane may be characterized by two parameters: permeate flux and solute passage. The permeate flux parameter indicates the rate of permeate flow per unit area per unit pressure of membrane. To facilitate comparison during testing, the pressure and area terms may be normalized out, resulting in a unitless parameter indicating permeate flow. The solute passage parameter indicates the ability of the membrane to retain certain components while passing others, and may be expressed as a percentage of the concentration of the solute in the initial solution.

Traditional RO membranes may be constructed as composite membranes having a thin barrier layer formed as an insoluble polymer layer on top of a micro-porous membrane support material. The micro-porous membrane support material may be a sheet of polysulfone. The insoluble polymer layer may be formed by the interfacial polymerization of reactants poured over this micro-porous membrane support. This technique forms a crosslinked network polymer layer that may have numerous free chain ends isolated throughout the matrix. These insoluble polymer layers may be made from, for example, polyamides or polysulfonamides. A typical composite membrane having a polyamide layer formed over a polysulfone support material, will have a permeate flux of about 8, and a solute passage of around 2% or less. These parameters are often controlled by the thickness and number of imperfections of the membrane, and may also be affected by the number of free chain ends in the matrix. A thicker membrane will have lower solute passage, and a correspondingly lower permeate flux. Although a thinner membrane will have a greater flux, the probability of holes or void spaces causing leakage across the membrane increases, leading to higher solute passage. Furthermore, the presence of fewer free chain ends may correspond to less free volume in the matrix, which may result in a lower solute passage.

It may be desirable to purify a large amount of solution in a short period of time. Thus, it may be desirable to facilitate high flow rates of solvent through a membrane, while preventing a high percentage of solute from passing through the membrane. It may be desirable to make and/or use a membrane or system that differs from those membranes and systems that are currently available. It may be desirable to provide a membrane that has a high permeate flux and low solute passage than membranes that are currently available.

### BRIEF DESCRIPTION

In one embodiment, a membrane assembly includes a micro-porous support coated with an insoluble polymer layer. The insoluble polymer coating is formed using at least one reactant solution containing a chain-capping reagent.

In one embodiment, a filtration unit has a holder containing the membrane assembly. The membrane assembly has a support made from a micro-porous material, which is coated with an insoluble polymer. The insoluble polymer coating is formed using at least one reactant solution containing a chain-capping reagent.

In one embodiment, a filtration system includes at least one high pressure pump and one or more filtration units, wherein the pump is configured to provide a continuous high pressure flow of water through the filtration units. At least one of the filtration units contains a membrane assembly. The membrane assembly has a support, made from a micro-porous material, which is coated with an insoluble polymer. The insoluble polymer coating is formed using at least one reactant solution comprising a chain-capping reagent.

In one embodiment, a method makes a membrane for reverse osmosis. In the method, a micro-porous support is treated with a water solution, a first reactant solution, and then with a second reactant solution. The first reactant solution, the second reactant solution, or both may contain a chain-capping reagent. In one aspect, the chain-capping reagent may be one or more compositions selected from acid halides, acid anhydrides, alkyl halides, aryl halides, aldehydes, organic cyclic oxides, or sultones.

### DRAWINGS

FIG. 1 is a block diagram of a reverse osmosis process in accordance with embodiments of the invention;

FIG. 2 is a perspective view of a stack of reverse osmosis cartridges in accordance with embodiments of the invention;

FIG. 3 is a perspective view of a reverse osmosis cartridge with a cut-away section in accordance with embodiments of the invention; and

FIG. 4 is a block diagram of a process for producing a reverse osmosis membrane and cross-sectional views of the membrane in accordance with embodiments of the invention.

### DETAILED DESCRIPTION

The invention includes embodiments that relate to a membrane. The invention includes embodiments that relate to a water treatment system. The invention includes embodiments that relate to a method of making and/or using a membrane and a water treatment system.

In one embodiment, a reverse osmosis membrane assembly may have higher permeate flux and lower solute passage than traditional RO membranes. This membrane may be formed by adding a chain-capping reagent to one of the reactants to decrease the number of free chain ends. The technique takes advantage of the slower reaction rate for chain-capping in comparison to the rate of interfacial polymerization.

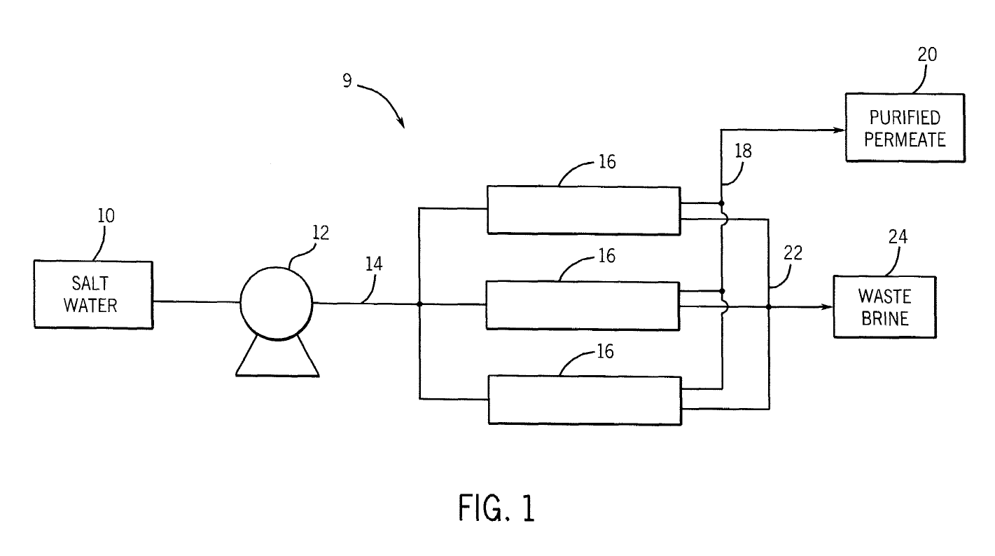

FIG. 1 is a drawing of a reverse osmosis system 9, in accordance with embodiments of the invention. In the illustrated embodiment, salt water from a salt water source tank 10 may be conveyed by a pump 12 through a series of lines 14 to one or more filtration units 16 that contain an RO membrane, in accordance with embodiments of the invention. Permeate lines 18 connected to the downstream side of the RO membranes collect the permeate and store it in a purified permeate tank 20 for further purification or for use.

Backpressure may be created in the filtration units 16 by devices (not shown) contained in the downstream retentate piping 22. In embodiments of the invention, such devices may include backpressure control valves or smaller line diameters, depending on the complexity of the system. The retentate, which is the concentrated solution after it has been passed over the RO membrane, is collected in a waste brine tank 24, and may be discarded or recycled into the saltwater source tank for further purification.

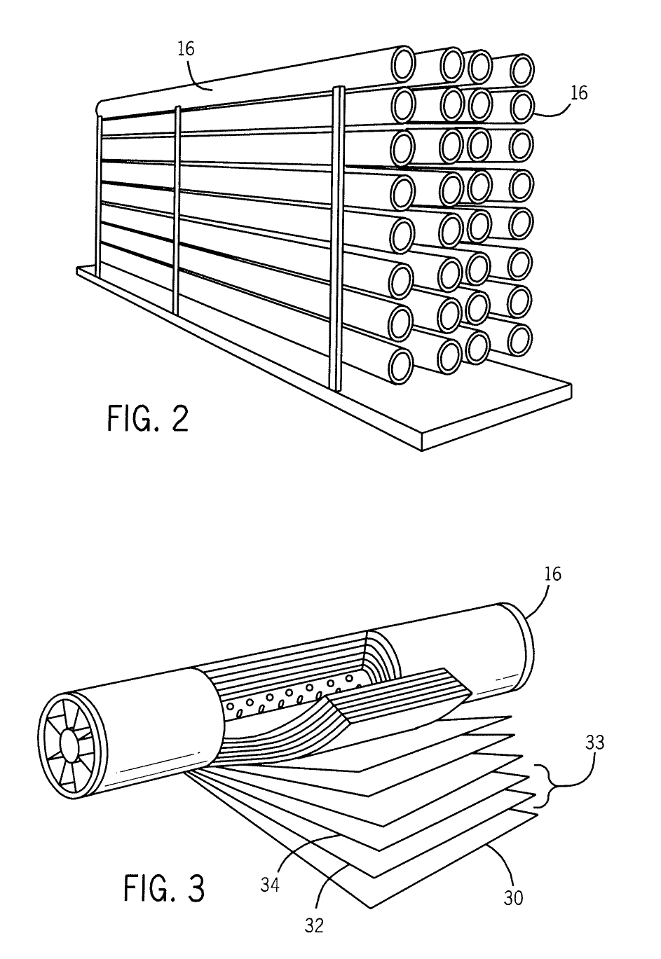

FIG. 2 is a prospective view of exemplary filtration units 16 that may be used in a system, in accordance with embodiments of the invention. The cylindrical shape of the filtration units may allow the surface area of the membrane assembly 33 (see FIG. 3) to be maximized, while minimizing the footprint of the cartridge. Other embodiments have other geometries than the filtration unit 16. As shown by this view, an exemplary system may contain numerous filtration units 16 for purification. In addition to RO membrane filtration units, a water purification system may utilize other filtration units containing such materials as filtration media, activated carbon, silver biocides, or numerous other types of treatment materials. Other cartridges may be used in parallel or sequential arrangements for water purification.

FIG. 3 illustrates a cut away view of a filtration unit 16 showing a support layer 30 holding an RO membrane assembly 33. Suitable support layers may include a steel mesh or a steel plate with holes. The RO membrane assembly has a microporous membrane support 32 covered with an insoluble polymer layer 34. Suitable microporous membranes may include polyolefins, polyamides, polyimides, polyetherimides, polysulphones, and the like. Suitable polyolefins may include polyethylene, polypropylene, and halogenated derivatives thereof. In one embodiment, the microporous membrane may include polytetrafloroethylene. The insoluble polymer layer 34 provides the RO functionality to the RO membrane assembly 33. In other words, the insoluble polymer layer 34 facilitates permeation of water through the RO membrane assembly 33 and prevents at least some salt ions and impurities from passing through the RO membrane assembly 33.

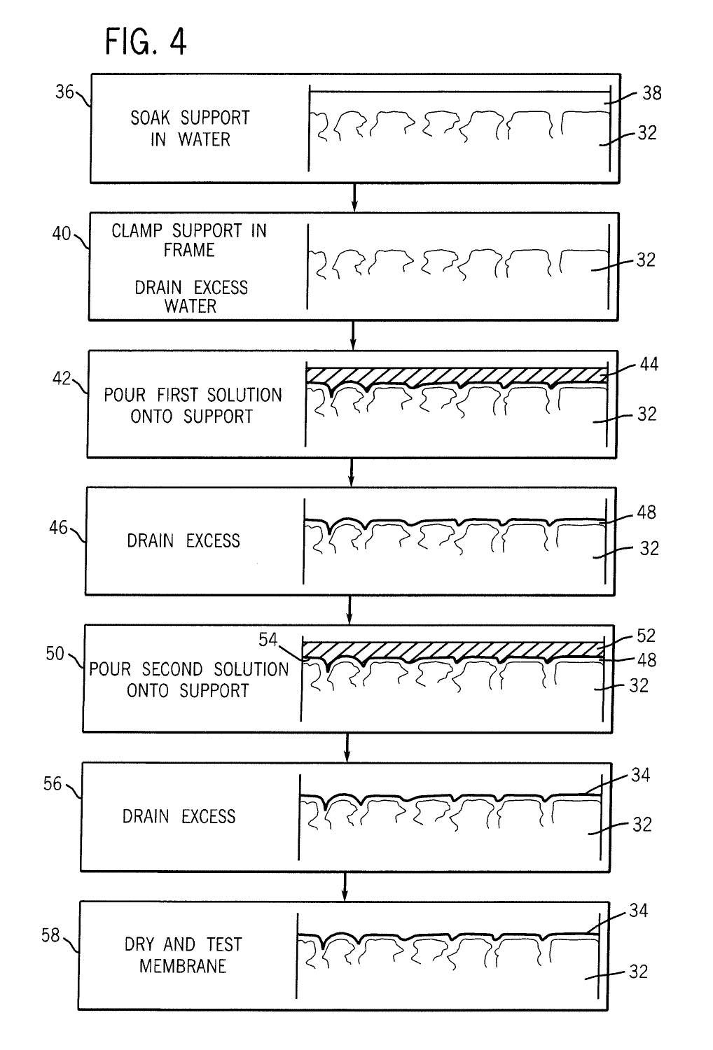

FIG. 4 is a block diagram illustrating the procedure for preparing the insoluble polymer 34 on the surface of the micro-porous membrane support 32, in accordance with embodiments of the invention. As shown in block 36, the micro-porous membrane support 32 may be soaked in water 38 for at least one hour. The membrane may then be left covered with water until immediately before forming of the insoluble polymer layer 34. In exemplary embodiments of the invention, the water may be purified by distillation, reverse osmosis, or deionization prior to use. In other embodiments of the invention, the water may comprise a surfactant containing carbon, oxygen, and silicon atoms. Such a surfactant may comprise one or more block or graft copolymers made up of two or more polymer chains, each polymer chain comprising at least one polymer chain containing 2-100 units of a hydrophilic monomer, such as propylene glycol, ethylene glycol, ethylene oxide, or a combination thereof, and at least one other polymer chain containing 2-100 units of siloxane, carbosilane units, silane, or a combination thereof. Surfactants that may be used in exemplary embodiments of the invention include:

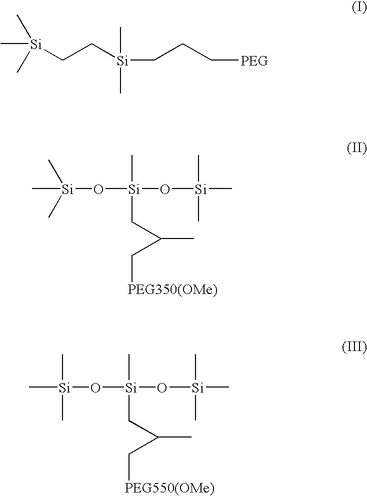

where PEG is polyethylene glycol, PEG350 is a PEG chain with a molecular weight of about 350, and PEG 550 is a PEG chain with a molecular weight of about 550.

Silicon based surfactants may increase the wetting of the micro-porous membrane support 32, leading either to a more even distribution of the reactant solutions 44, 52 across the surface of the micro-porous membrane support 32 or to an increase in the amount of monomer that is inculcated into the pores of the micro-porous membrane support 32 prior to the interfacial polymerization discussed below. These changes in the distribution of the reactant solutions may decrease the number of voids, or other imperfections, formed in the insoluble polymer layer 34, while increasing the surface area of the final membrane assembly 33.

Prior to forming the insoluble polymer layer, the support may be drained and clamped into a frame as shown in block 40. In block 42, a first reactant solution 44 containing a first reactant is poured over the surface of the micro-porous membrane support 32, and left on the surface for approximately 30 seconds. After 30 seconds, the first reactant solution 44 is drained, as shown in block 46, and any residual droplets may be blown off with an air knife, leaving a thin residual layer 48 of the first reactant solution 44. In embodiments of the invention, the first reactant solution 44 may be an aqueous solution of an amine composition. Suitable amine compositions may include diamines and/or triamines. In one embodiment, the amine composition includes one or more aliphatic primary diamines, aliphatic secondary diamines, carbocyclic primary diamines, aliphatic primary triamines, aliphatic secondary triamines, or carbocyclic primary triamines. The carbocyclic amine compositions may include aromatic or aliphatic ring structures, and may additionally include heterocyclic ring structures. In an exemplary embodiment, the amine composition is metaphenylene diamine (mPD), which has the chemical structure:

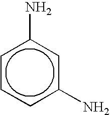

In other embodiments the first reactant solution 44 may be an organic solution of an acyl halide composition. Suitable acyl halide compositions may include one or more of aliphatic diacyl halides, aliphatic triacyl halides, carbocyclic diacyl halides, carbocyclic triacyl halides. The carbocyclic acyl halide compositions may include either aromatic or aliphatic ring structures. Furthermore, if the first reactant solution 44 is an organic solution containing an acyl halide, an aqueous solution containing a bisphenol composition will be used for the second reactant solution 52.

The first reactant solution 44 may contain other compositions to enhance the reaction, or modify the properties of the final membrane, such as triethylamine, and camphorsulfonic acid. The first reactant solution 44 may also contain a surfactant, as described above, instead of, or in addition to, adding a surfactant to any other solution. As discussed with respect to block 36, the surfactant may comprise one or more block or graft copolymers made up of two or more polymer chains, each polymer chain comprising at least one polymer chain containing 2-100 units of a hydrophilic monomer and at least one other polymer chain containing 2-100 units of siloxane, carbosilane units, or silane. Suitable hydrophilic monomers may include one or more of propylene glycol, ethylene glycol, or ethylene oxide. Furthermore, the first reactant solution 44 may contain a chain-capping agent to decrease the number of free chain ends left after the reaction is complete. In one embodiment, the chain-capping agents may include acid halides, acid anhydrides, alkyl halides, aryl halides, aldehydes, organic cyclic oxides, and sultones. In one embodiment, chain-capping reagents may include bromoacetic acid (BrAA); benzyl chloride; benzoyl chloride; benzenesulphonyl chloride; 2-(2-bromoethyl)-1,3-dioxane; 1,4-dibromo-2,3-butanedione; 2-bromoethyl-2-bromoacetate; 1,2-bis(bromoacetoxy)ethane; 1,3-propane sultone; or 1,4-butane sultone.

The chain-capping reagents with free amine compositions in exemplary embodiments of the first reactant solution 44 may be slower then the formation of the membrane itself. The chain-capping reagent may be added to the first reactant solution 44 immediately before use, and does not significantly react with the free amine chain ends until the membrane is heated for drying, as shown in block 58 of FIG. 4. The terminated or capped chains may lower the free volume in the cross linked network of the polymer, decreasing the amount of salt ions conveyed through the structure. Furthermore, as shown by the examples below, silicon based surfactants may have a synergistic effect when used in concert with endcapping agents to increase the water flux and decreasing salt passage in exemplary membranes.

After the first reactant solution 44 has been drained from the micro-porous membrane support 32, a second reactant solution 52 containing a second reactant is carefully poured onto the micro-porous membrane support 32, as shown in block 50. In one embodiment, the second reactant solution 52 may be an organic solution of an acyl halide. Suitable acyl halides may include one or more of aliphatic diacyl halides, aliphatic triacyl halides, carbocyclic diacyl halides, or carbocyclic triacyl halides. The carbocyclic acyl halide compositions may include either aromatic or aliphatic ring structures, and may additionally include heterocyclic ring structures. In an exemplary embodiment, the second reactant solution 52 may be an organic solution containing trimesitoyl chloride, which has the chemical structure:

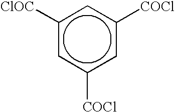

In one embodiment, the second reactant solution 52 may be an organic solution containing a sulfonyl halide. Suitable sulfonyl halides may include one or more aliphatic disulfonyl halides, aliphatic trisulfonyl halides, a carbocyclic disulfonyl halides, or a carbocyclic trisulfonyl halides. The carbocyclic sulfonyl halide compositions may include either aromatic or aliphatic ring structures, and may additionally include heterocyclic ring structures. In one embodiment, the organic solvent may be an alkane or an arene. In one embodiment, the organic solvent may be an isoparaffinic solvent, such as Isopar G™, available from Exxon Mobil™. The second reactant solution 52 may contain a surfactant instead of, or in addition to, adding a surfactant to any other solution. As discussed with respect to block 36, the surfactant may comprise one or more block or graft copolymers made up of two or more polymer chains, each polymer chain comprising at least one polymer chain containing 2-100 units of a hydrophilic monomer, such as propylene glycol, ethylene glycol, ethylene oxide, or a combination thereof, and at least one other polymer chain containing 2-100 units of siloxane, carbosilane units, or silane. Furthermore, the second reactant solution 52 may contain a chain-capping reagent instead of, or in addition to, adding a chain-capping reagent to any other solution. In one embodiment in which the second reactant solution 52 comprises an organic solvent, a cosolvent may be added to improve the solubility of the chain-capping reagent. Suitable cosolvents may include butyl acetate, acetonitrile, nitromethane, anisole, ethyl cyanoacetate, ethyl acetate, xylene, and cyclohexanone.

Upon pouring in the second reactant solution 52, a polymerization reaction takes place at the interface 54 between the second reactant dissolved in the second reactant solution 52 and the residue 48 containing the first reactant, left on the surface after the first reactant solution 44 was poured off. This polymerization forms a network constituting an insoluble polymer layer 34, on the surface of the micro-porous membrane support 32. The insoluble polymer layer is from about 40 nanometers to about 100 nanometers thick. If the first reactant is an amine and the second reactant is an acyl halide, the resultant insoluble polymer layer 34 is a polyamide. If the first reactant is an acyl halide and the second reactant is a bisphenol composition the resultant insoluble polymer layer 34 is a polyester. Furthermore, if the first reactant is an amine and the second reactant is a sulfonyl halide, the resulting insoluble polymer layer 34 is a polysulfonamide. In an exemplary embodiment, the insoluble polymer layer 34 may be an aryl polyamide, also known as a polyaramide, with a chemical structure as shown below:

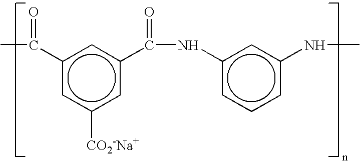

The reaction may be allowed to progress for a short period of time, and then the second reactant solution 52 is drained from the surface, as shown in block 56. In exemplary embodiments, this period of time may be approximately one minute. Changes to the reaction parameters, such as reaction time, may result in different properties for the insoluble polymer layer 34. After the solutions have been drained, the final membrane assembly 33 (see FIG. 3) comprising both the micro-porous membrane support 32 and the insoluble polymer layer 34 may be blown dry to remove any excess droplets of the solution, and then oven dried, as shown in block 58. In exemplary embodiments, the membrane assembly may be dried at about 100 degrees Celsius for about 6 minutes.

Membrane assemblies 33 formed using the procedures discussed above may affect flux and salt passage properties to differ from control samples. In the examples discussed below, the first reactant solution 44 is an aqueous solution containing 2% metaphenylenediamine, 3.3% triethylamine, and 3.3% camphorsulfonic acid. The second reactant solution 52 contained 0.12% trimesitoyl chloride, dissolved in Isopar G™. Varying amounts of chain-capping reagents are added to the first or second reactant solution, as described for each series of examples. Following the procedures detailed above, the solutions react for approximately 1 min, and are dried with an air knife prior to oven drying. The samples are tested for flux and salt passage.

### EXAMPLES 1-4

With reference to Table 1, Examples 1-4 show membrane performance that may be obtained by incorporating chain-capping reagents and surfactants into the aqueous phase of the first reactant solution 44. Example 1 is a control that has no added chain-capping reagents or surfactants in either phase. In contrast, Example 2 shows that adding a surfactant containing silicon, carbon, and oxygen atoms to the aqueous phase may increase flux, with a smaller corresponding increase in the salt passage. Example 3 shows the addition of an endcapping reagent, bromo-acetic acid (BrAA), to the aqueous phase increases the flux over the control, while reducing the salt passage. The addition of both a surfactant and the BrAA to the aqueous phase may have a synergistic effect, as shown by Example 4. As shown in Example 4, adding both may increase the flux over that of the surfactant by itself, and may decrease salt passage from that of the surfactant by itself.

### EXAMPLES 5-12

Many of the chain-capping reagents tested have minimal solubility in organic solvents, such as the second reactant solution 52 of these examples. To improve the solubility of these reagents, a cosolvent may be added to the organic phase. Examples 5-12 show the effects on membrane performance of incorporating a cosolvent into the organic phase, without the presence of either an additional endcapping reagent or a surfactant. As shown by the results obtained for Example 8, 1% of anisole added to the ISOPAR G solution may have a minimal effect on the final properties of the membrane. Other cosolvents that may be used, such as ethyl actate (Example 10) and cyclohexanone (Example 12) may have greater effects, indicating that they may participate in the reaction. Accordingly, anisole may be an appropriate cosolvent to compare the performance of different chain-capping reagents, as shown in Examples 13-18, depending on the solubility of the chain-capping reagent.

### EXAMPLES 13-18

Examples 13-18 compare different chain-capping reagents to determine the effects their use may have on the final performance of the membrane. In most cases, the listed chain-capping reagents were sufficiently soluble in ISOPAR G that no cosolvent was needed. However, in the case of benzene-1,3-di(sulfonyl chloride) and BrAA, shown in Examples 17 and 18, 1% anisole was added to the organic phase to increase the solubility. In comparisons of these compositions, the optimum values for flux may be obtained using BrAA as a chain-capping reagent in the organic phase.

### EXAMPLES 19-25

Anisole may not provide a sufficient solubility increase for dissolution of all chain-capping reagents, such as those listed in Examples 19-25. Due to the low solubility of these compositions, more efficient cosolvents, such as xylene or cyclohexanone, may be required. To account for the differences in membrane performance caused by the cosolvents themselves, control runs including these solvents without any additional chain-capping reagents are included, as shown by Examples 19 and 23. As the results in Examples 19-25 demonstrate, significant gains in performance may be achieved using a number of chain-capping compositions, such as diesters and sultones.

### EXAMPLES 26-29

The concentration of the chain-capping reagent used may affect the final properties. This may be demonstrated by Examples 26-29, which show the effects on membrane performance of changing the concentration of BrAA added to the organic phase. To improve the solubility of the BrAA, 1% of anisole is added to the ISOPAR G™ as a cosolvent. These examples indicate that the maximum improvement in the flux may be achieved by the addition of 0.15% BrAA. Further increases in the BrAA concentration may decrease the flux, and may increase the salt passage across the membrane.

### EXAMPLES 30-34

Further improvements may be possible if chain-capping reagents are included in more then one of the reactant solutions. As indicated by Examples 30-34, a synergistic effect may be obtained when the chain-capping reagent is included in both the organic and aqueous phases. As a control, Example 30 shows the results that may be obtained when the chain-capping reagent BrAA is incorporated solely in the water phase. By comparison, Examples 31 and 33 indicate that higher flux may be achieved by incorporating the BrAA into the organic phase. Examples 32 and 34 show that an even higher flux may be possible by incorporating the chain-capping reagent into both phases. However, incorporation of the BrAA into both phases may also result in an increase in the values for the salt passage.

Reference is made to substances, components, or ingredients in existence at the time just before first contacted, formed in situ, blended, or mixed with one or more other substances, components, or ingredients in accordance with the present disclosure. A substance, component or ingredient identified as a reaction product, resulting mixture, or the like may gain an identity, property, or character through a chemical reaction or transformation during the course of contacting, in situ formation, blending, or mixing operation if conducted in accordance with this disclosure with the application of common sense and the ordinary skill of one in the relevant art (e.g., chemist). The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

TABLE 1

| | Phase with Chain | | | | Salt |
|---|---|---|---|---|---|
| Example | Capping Reagent | Cosolvent | Chain-capping Reagent | Flux (A) | Passage (%) |
| 1 | n/a | n/a | n/a | 7.97 ± 0.48 | 1.36 ± 0.40 |
| 2 | n/a | n/a | silicon based surfactant | 13.1 ± 0.75 | 1.87 ± 0.83 |
| 3 | aqueous | n/a | bromoacetic acid (BrAA) | 9.38 ± 0.3 | 0.87 ± 0.20 |
| 4 | aqueous | n/a | BrAA + Si-surfactant | 15.95 ± 0.3 | 1.19 ± 0.13 |
| 5 | organic | butyl acetate (1%) | None | 8.25 ± 0.15 | 3.15 ± 0.65 |
| 6 | organic | acetonitrile (1%) | None | 8.15 ± 0.25 | 8.7 ± 5.9 |
| 7 | organic | nitromethane (1%) | None | 7.25 ± 0.45 | 3.05 ± 0.05 |
| 8 | organic | anisole (1%) | None | 8.40 ± 0.10 | 1.5 ± 0.9 |
| 9 | organic | ethyl cyanoacetate (1%) | None | 8.15 ± 0.15 | 1.35 ± 0.55 |
| 10 | organic | ethyl acetate (2.5%) | None | 12.6 ± 0.1 | 2.3 ± 0.8 |
| 11 | organic | xylene (2.5%) | None | 9.6¹ | 1.19¹ |
| 12 | organic | cyclohexanone (2.5%) | None | 15.11¹ | 1.75¹ |
| 13 | organic | none | benzyl chloride (0.3%) | 8.3/8.3 | 2.2 ± 0.8 |
| 14 | organic | none | benzoyl chloride (0.35%) | 6.95 ± 0.25 | 2.8 ± 1.6 |
| 15 | organic | none | benzenesulphonyl chloride (0.5%) | 8.7 ± 0.2 | 2.0 ± 0.4 |
| 16 | organic | none | 2-(2-bromoethyl)-1,3-dioxane (0.5%) | 10.4 ± 0.2 | 2.1 ± 0.5 |
| 17 | organic | anisole (1%) | benzene-1,3-di(sulfonyl chloride) (0.35%) | 2.7 ± 0.6 | 2.8 ± 0.14 |
| 18 | organic | anisole (1%) | BrAA (0.3%) | 13.6 ± 0.25 | 4.8 ± 0.36 |
| 19 | organic | xylene (2.5%) | None | 9.6 ± 0.15 | 1.19 ± 0.63 |
| 20 | organic | xylene (2.5%) | 1,4-dibromo-2,3-butanedione (0.12%) | 12.7 ± 0.3 | 1.23 ± 0.15 |
| 21 | organic | xylene (2.5%) | 2-bromoethyl-2-bromoacetate | 12.1 ± 0.35 | 1.32 ± 0.5 |
| 22 | organic | xylene (2.5%) | 1,2-bis(bromoacetoxy)ethane | 12 ± 0.76 | 2.3 ± 1.3 |
| 23 | organic | cyclohexanone (2.5%) | None | 15.1 ± 0.9 | 1.75 ± 0.45 |
| 24 | organic | cyclohexanone (2.5%) | 1,3-propane sultone | 17.7 ± 0.5 | 1.9 ± 0.3 |
| 25 | organic | cyclohexanone (2.5%) | 1,4-butane sultone | 17.3 ± 0.15 | 2.5 ± 0.5 |
| 26 | organic | anisole (1%) | BrAA (0.10%) | 13.1¹ | 1.63¹ |
| 27 | organic | anisole (1%) | BrAA (0.15%) | 14.9¹ | 2.08¹ |
| 28 | organic | anisole (1%) | BrAA (0.30%) | 13.6¹ | 4.82¹ |
| 29 | organic | anisole (1%) | BrAA (0.50%) | 14¹ | 12¹ |
| 30 | aqueous | n/a | BrAA | 9.4¹ | 0.9¹ |
| 31 | organic | anisole (1%) | BrAA | 14.9¹ | 2.08¹ |
| 32 | organic | anisole (1%) | BrAA | 15.7¹ | 3.6¹ |
| 33 | both | cyclohexanone (2.5%) | BrAA | 16.2¹ | 2.8¹ |
| 34 | both | cyclohexanone (2.5%) | BrAA | 21.5¹ | 4.22¹ |

¹Reflects a single run. This value may represent a range.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product or final material.

The embodiments described herein are examples of compositions, structures, systems and methods having elements corresponding to the elements of the invention recited in the clauses. This written description may enable those of ordinary skill in the art to make and use embodiments having alternative elements that likewise correspond to the elements of the invention recited in the clauses. The scope of the invention thus includes compositions, structures, systems and methods that do not differ from the literal language of the clauses, and further includes other structures, systems and methods with insubstantial differences from the literal language of the clauses. While only certain features and embodiments have been illustrated and described herein, many modifications and changes may occur to one of ordinary skill in the relevant art. The appended clauses cover all such modifications and changes.

1. A membrane assembly, comprising:
a support comprising a micro-porous material; and
an insoluble layer secured to a surface of the support, wherein the insoluble layer is a reaction product of a reactant solution comprising a chain-capping reagent.

2. The membrane assembly as defined in claim 1, wherein the support comprises a polysulfone or polyolefin, or halogenated derivatives of polysulfone or polyolefin.

3. The membrane assembly as defined in claim 1, wherein the support comprises a fibrous micro-porous substrate or a sand composite support.

4. The membrane assembly as defined in claim 1, wherein the insoluble layer is a polymer coating formed by interfacial polymerization

5. The membrane assembly as defined in claim 1, wherein the insoluble layer is a reaction product of metaphenylene diamine and trimesitoyl chloride.

6. The membrane assembly as defined in claim 1, wherein the insoluble layer is a reaction product of ingredients and a surfactant.

7. The membrane assembly as defined in claim 1, wherein the surfactant comprises a polymeric composition comprising repeat units of ethylene glycol, propylene glycol, or ethylene oxide.

8. The membrane assembly as defined in claim 1, wherein the surfactant comprises a polymeric composition comprising siloxane, carbosilane, or silane.

9. The membrane assembly as defined in claim 1, wherein the support has an amount of a surfactant disposed on the support surface under the insoluble layer.

10. The membrane assembly as defined in claim 9, wherein the insoluble layer is formed using an aqueous reactant solution comprising the surfactant.

11. The membrane assembly as defined in claim 9, wherein the insoluble layer is formed using an organic solution comprising the surfactant.

12. The membrane assembly as defined in claim 1, wherein the reaction solution comprises at least one diamine.

13. The membrane assembly as defined in claim 12, wherein the diamine is an aliphatic primary diamine, an aliphatic secondary diamine, or a carbocyclic primary diamine.

14. The membrane assembly as defined in claim 1, wherein the reaction solution comprises at least one triamine.

15. The membrane assembly as defined in claim 14, wherein the triamine is an aliphatic primary triamine, an aliphatic secondary triamine, or a carbocyclic primary triamine.

16. The membrane assembly as defined in claim 1, wherein the reaction solution comprises at least one of an aliphatic disulfonyl halide, an aliphatic trisulfonyl halide, a carbocyclic disulfonyl halide, or a carbocyclic trisulfonyl halide.

17. The membrane assembly as defined in claim 1, wherein the chain-capping composition comprises at least one material selected from the group consisting of organic acid halide and organic salt halide.

18. The membrane assembly as defined in claim 17, wherein the chain-capping composition comprises one or more of bromoacetic acid; benzyl chloride; benzoyl chloride; benzenesulphonyl chloride; 2-(2-bromoethyl)-1,3-dioxane; 1,4-dibromo-2,3-butanedione; 2-bromoethyl-2-bromoacetate; and 1,2-bis (bromoacetoxy ethane.

19. The membrane assembly as defined in claim 1, wherein the chain-capping composition comprises 1,3-propane sultone or 1,4-butane sultone.

20. The membrane assembly as defined in claim 1, wherein the at least one reactant solution comprises a mixture of two or more organic solvents that differ from each other.

21. The membrane assembly as defined in claim 1, wherein the reactant solution comprises at least one solvent selected from the group consisting of butyl acetate; acetonitrile; nitromethane; anisole; ethyl cyanoacetate; ethyl acetate; xylene; and cyclohexanone.

22. A filtration cartridge comprising a holder, and disposed within the holder is a membrane assembly as defined in claim 1.

23. A filtration system comprising:
at least one high pressure pump; and
one or more filtration units, wherein the pump provides a pressurized flow of water through the filtration units, and at least one of the filtration units has disposed therein the membrane assembly as defined in claim 1.

24. A method, comprising:
contacting a micro-porous support with a water solution;
contacting the micro-porous support with a first reactant solution; and
contacting the micro-porous support with a second reactant solution, wherein at least one of the first reactant solution or the second reactant solution comprises a chain-capping reagent.
